(19) United States
(12) Patent Application Publication
(10) Pub. No.: US 2025/0239859 A1
(43) Pub. Date: Jul. 24, 2025

(54) DECISION-MAKING METHOD AND SYSTEM FOR EMERGENCY FREQUENCY CONTROL OPTIMIZATION IN OFF-GRID PROCESS OF POWER DISTRIBUTION SYSTEM

(71) Applicant: BEIJING JIAOTONG UNIVERSITY, Beijing (CN)

(72) Inventors: Xiangyu WU, Beijing (CN); Yin XU, Beijing (CN); Ying WANG, Beijing (CN); Zhao LIU, Beijing (CN); Atao WU, Beijing (CN); Yingjie GAO, Beijing (CN); Ziyuan WANG, Beijing (CN)

(21) Appl. No.: 19/175,793

(22) Filed: Apr. 10, 2025

(30) Foreign Application Priority Data
Sep. 2, 2024 (CN) 202411219913.2

(51) Int. Cl. H02J 3/38; H02J 3/24

(52) U.S. Cl. CPC H02J 3/381; H02J 3/241; H02J 2203/20; H02J 2300/28

(57) ABSTRACT

The present application provides a decision-making method and system for emergency frequency control optimization in an off-grid process of a power distribution system, and relates to the technical field of frequency control of the power distribution system. An average system frequency response model of the power distribution system is established; a frequency deviation is approximated as a quadratic function under a reasonable assumption that an increase in active power generation of the system increases approximately linearly with time, to perform open-loop processing on the frequency response model, so as to obtain an open-loop model; decisions are made on control quantities of fast power control resources within the power distribution system, and an emergency frequency control optimization model of the power distribution system is established; and the emergency frequency control optimization model is solved to obtain a decision-making emergency control scheme with a minimum cost of emergency control measures.

### CROSS REFERENCE TO RELATED APPLICATION

This patent application claims the benefit and priority of Chinese Patent Application No. 202411219913.2, filed with the China National Intellectual Property Administration on Sep. 2, 2024, the disclosure of which is incorporated by reference herein in its entirety as part of the present application.

### TECHNICAL FIELD

The present disclosure relates to the technical field of frequency control of a power distribution system, and in particular, to a decision-making method and system for emergency frequency control optimization in an off-grid process of a power distribution system.

### BACKGROUND

The power distribution system typically exhibits characteristics such as a high proportion of external power supply, operation across multiple voltage levels, and coexistence of various types of heterogeneous power sources. In scenarios where extreme events lead to the destruction of key power transmission paths, the complete loss of voltage at substations, or instability in the upper grid, the power distribution system may disconnect from the upper grid. At the moment of disconnection, a significant active power deficit can cause substantial frequency fluctuations, making the off-grid control challenging. Therefore, it is of great significance to coordinate various resources, including generation, load, and storage, within the power distribution system for emergency frequency control, enabling the smooth transition to islanded operation and ensuring uninterrupted power supply to critical loads.

Accurately establishing a system frequency response model is the foundation for emergency frequency control during the off-grid process. Classical frequency response models in power systems include the average system frequency (ASF) model and the system frequency response (SFR) model. The ASF model preserves the dynamic characteristics of all generators and aggregates the output power, applying the same to an equivalent rotor to obtain the dynamic behavior of the ASF. The SFR model represents all generator governor systems as an equivalent reheat control system and simplifies the power grid into a single-machine model. The large-scale integration of renewable energy introduces new characteristics in frequency response of the power system, which mainly involves technologies such as fast power control or virtual inertia control for system frequency control. To reflect the impact of renewable energy on the characteristics of the SFR, corresponding branches or modules can be added to the frequency response model.

In terms of emergency frequency control methods, existing research on off-grid control strategies typically focuses on solving emergency control optimization decision-making models, with emphasis on how to establish frequency safety constraints based on the frequency response models. Reference [Ke Deping, Feng Shuaishuai, Liu Fusuo, et al. Rapid Optimization for Emergent Frequency Control Strategy with the Power Regulation of Renewable Energy during the Loss of DC Connection [J]. Transactions of China Electrotechnical Society, 2022, 37 (05):1204-1218] proposes an optimization model for the emergency frequency control strategy based on cooperating the renewable energy plants and conventional generators, to discretize the SFR model using the difference method and transform the model into a standard mixed-integer linear programming (MILP) problem. Reference [Wei Jiuming, Li Zhaowei, Li Bijun, et al. Emergency Control Strategies Using Energy Storage to Enhance Transient Frequency Safety Under Short-time Power Impact of Renewable Energy [J]. Automation of Electric Power Systems, 2024, 48 (08): 152-161.] simplifies the frequency response model to obtain a time-domain expression of the system frequency response considering the emergency power control using energy storage. Reference [Zheng Shi, Yin Xu, Ying Wang, Jinghan He, et al. Coordinating Multiple Resources for Emergency Frequency Control in the Energy Receiving-End Power System with HVDCs [J]. IEEE Transactions on Power Systems, 2023, 38(5):4708-4723.] uses a parameter aggregation method to reduce the order of the SFR model considering multiple resources, deriving a time-domain approximate analytical expression for the extreme value points of the system frequency. Most of the frequency response expressions in the above studies are derived from simplified models and rarely consider control delays and resource aggregation. The frequency response model of the power distribution system is more complex and of a higher order, involving multiple fast power control resources with different delays. As a result, conventional emergency frequency control research outcomes are not directly applicable, and there is an urgent need to explore emergency frequency control strategies suitable for the power distribution system.

### SUMMARY

The purpose of the present disclosure is to provide a decision-making method and system for emergency frequency control optimization in an off-grid process of a power distribution system, so as to solve at least one technical problem in the above background art.

To achieve the foregoing objective, the present disclosure adopts the following technical solutions:

According to a first aspect, the present disclosure provides a decision-making method for emergency frequency control optimization in an off-grid process of a power distribution system, including:
obtaining frequency regulation parameters of power generators and a magnitude of a load disturbance, and establishing an average system frequency response model of the power distribution system based on an average system frequency response model;
approximating a frequency deviation as a quadratic function based on the average system frequency response model of the power distribution system and under a reasonable assumption that an increase in active power generation of the system increases approximately linearly with time, to perform open-loop processing on the frequency response model, so as to obtain an open-loop model;
making decisions on control quantities for fast power control resources within the power distribution system based on the open-loop model, and establishing an emergency frequency control optimization model of the power distribution system; and
solving the emergency frequency control optimization model of the power distribution system, to obtain a decision-making emergency control scheme with a minimum cost of emergency control measures.

Further, said establishing an average system frequency response model of the power distribution system includes: obtaining frequency regulation parameters of a wind power generator and a conventional power generator and the magnitude of the load disturbance; based on the frequency regulation parameter of the wind power generator, deriving, using a small-signal analysis method, a wind power-frequency transfer function considering working point shifting; obtaining a frequency response transfer function of the conventional power generator based on the frequency regulation parameter of the conventional power generator; and based on the load disturbance, constructing the average system frequency response model of the power distribution system with reference to the wind power-frequency transfer function and the frequency response transfer function of the conventional power generator.

Further, said approximating a frequency deviation as a quadratic function based on the average system frequency response model of the power distribution system and under a reasonable assumption that an increase in active power generation of the system increases approximately linearly with time, to perform open-loop processing on the frequency response model, so as to obtain an open-loop model includes: simulating the increase in active power generation of the system using a linear function since the increase in active power generation of the system increases approximately linearly with time after a disturbance occurs in the power system, where the increase in active power generation of the system is equal to a power deficit when frequency reaches a lowest point; after the disturbance occurs, describing a frequency response process of the power system using a rotor motion equation; and integrating the rotor motion equation to obtain a time-domain expression of the frequency.

Further, a Laplace transform is performed on the obtained time-domain expression of the system frequency, to determine the increase in active power generation of the system after the disturbance occurs; an inverse Laplace transform is performed on the increase in active power generation of the system after the disturbance occurs, to obtain a time-domain expression of the increase in active power generation of the system after the disturbance occurs; and when t=t_{nadir}, imbalance power of the system is 0, and the emergency frequency control optimization model of the power distribution system is established.

According to a second aspect, the present disclosure provides a decision-making system for emergency frequency control optimization in an off-grid process of a power distribution system, including:
a first establishing module configured to obtain frequency regulation parameters of power generators and a magnitude of a load disturbance, and establish an average system frequency response model of the power distribution system based on an average system frequency response model;
an open-loop module configured to approximate a frequency deviation as a quadratic function based on the average system frequency response model of the power distribution system and under a reasonable assumption that an increase in active power generation of the system increases approximately linearly with time, to perform open-loop processing on the frequency response model, so as to obtain an open-loop model;
a second establishing module configured to make decisions on control quantities for fast power control resources within the power distribution system based on the open-loop model, and establish an emergency frequency control optimization model of the power distribution system; and
a solving module configured to solve the emergency frequency control optimization model of the power distribution system, to obtain a decision-making emergency control scheme with a minimum cost of emergency control measures.

According to a third aspect, the present disclosure provides a non-transitory computer-readable storage medium. The non-transitory computer-readable storage medium stores a computer instruction, and the computer instruction is executed by a processor to achieve the decision-making method for emergency frequency control optimization in an off-grid process of a power distribution system according to the first aspect.

According to a fourth aspect, the present disclosure provides a computer device, including a memory and a processor. The processor communicates with the memory, the memory stores a program instruction executable by the processor, and the processor calls the program instruction to perform the decision-making method for emergency frequency control optimization in an off-grid process of a power distribution system according to the first aspect.

According to a fifth aspect, the present disclosure provides an electronic device, including: a processor, a memory, and a computer program. The processor is connected with the memory, the computer program is stored in the memory, and when the electronic device runs, the processor executes the computer program stored in the memory, to enable the electronic device to execute instructions for achieving the decision-making method for emergency frequency control optimization in an off-grid process of a power distribution system according to the first aspect.

The present disclosure has the following beneficial effects: The frequency deviation is approximated as the quadratic function under a reasonable assumption that the increase in active power generation of the system increases approximately linearly with time, to perform open-loop processing on the frequency response model; the lowest frequency point and the expression of the increase in active power generation of the system are obtained based on the open-loop model; decisions are made on the control quantities of the fast power control resources within the power distribution system, to ensure that the system frequency safety index and the like in the decision-making emergency control scheme meet the requirements with the minimum cost of emergency control measures.

The additional aspects and advantages of the present disclosure will become clear in the following description, or be learned through the practice of the present disclosure.

### BRIEF DESCRIPTION OF THE DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic flowchart of emergency frequency control in an off-grid process of a power distribution system according to an embodiment of the present disclosure;

FIG. 2 is an example information diagram of a power distribution system according to an embodiment of the present disclosure;

FIG. 3 is a schematic diagram of a frequency response model of a power distribution system according to an embodiment of the present disclosure; and

FIG. 4 is an effect diagram of emergency frequency control of a power distribution system according to an embodiment of the present disclosure.

### DETAILED DESCRIPTION OF THE EMBODIMENTS

The implementations of the present disclosure are described below in detail. Examples of the implementations are shown in the accompanying drawings. The same or similar numerals represent the same or similar elements or elements having the same or similar functions throughout the specification. The implementations described below with reference to the accompanying drawings are exemplary, and are only used to explain the present disclosure but should not be construed as a limitation to the present disclosure.

Those skilled in the art can understand that, unless otherwise defined, all terms (including technical terms and scientific terms) used herein have the same meanings as those commonly understood by those of ordinary skill in the art to which the present disclosure belongs.

It should also be understood that terms such as those defined in general dictionaries should be understood as having meanings consistent with the meanings in the context of the prior art, and unless otherwise defined herein, these terms will not be explained in ideal or overly-formal meanings.

Those skilled in the art can understand that, unless otherwise stated, the singular forms “a”, “an”, “said” and “the” used herein may also include plural forms. It should be further understood that the word “comprising” used in the specification of the present disclosure refers to the presence of the described features, integers, steps, operations, elements and/or components, but does not exclude the presence or addition of one or more other features, integers, steps, operations, elements, components, and/or a combination thereof.

In this specification, descriptions of reference terms such as “one embodiment”, “some embodiments”, “an example”, “a specific example”, and “some examples” indicate that specific features, structures, materials, or characteristics described in combination with the embodiment(s) or example(s) are included in at least one embodiment or example of the present disclosure. Moreover, the specific features, structures, materials, or characteristics described may be combined in a suitable manner in any one or more embodiments or examples. Those skilled in the art may combine different embodiments or examples described in this specification and characteristics of the different embodiments or examples without any contradiction.

In order to facilitate the understanding of the present disclosure, the present disclosure will be further explained below through specific examples in conjunction with the drawings, but these specific examples do not constitute a limitation to the examples of the present disclosure.

Those skilled in the art should understand that the drawings are only schematic diagrams of examples, and the components in the drawings are not necessary for implementing the present disclosure.

### Embodiment 1

In Embodiment 1, a decision-making system for emergency frequency control optimization in an off-grid process of a power distribution system is provided. The system includes: a first establishing module configured to obtain frequency regulation parameters of power generators and a magnitude of a load disturbance (i.e., power deficit of the power distribution system), and establish an average system frequency response model of the power distribution system based on an average system frequency response model; an open-loop module configured to approximate a frequency deviation as a quadratic function based on the average system frequency response model of the power distribution system and under a reasonable assumption that an increase in active power generation of the system increases approximately linearly with time, to perform open-loop processing on the frequency response model, so as to obtain an open-loop model; a second establishing module configured to make decisions on control quantities for fast power control resources within the power distribution system based on the open-loop model, and establish an emergency frequency control optimization model of the power distribution system; and a solving module configured to solve the emergency frequency control optimization model of the power distribution system, to obtain a decision-making emergency control scheme with a minimum cost of emergency control measures.

In this embodiment, the system can be used to implement a decision-making method for emergency frequency control optimization in an off-grid process of a power distribution system, including: obtaining frequency regulation parameters of power generators and a magnitude of a load disturbance, and establishing an average system frequency response model of the power distribution system based on an average system frequency response model; approximating a frequency deviation as a quadratic function based on the average system frequency response model of the power distribution system and under a reasonable assumption that an increase in active power generation of the system increases approximately linearly with time, to perform open-loop processing on the frequency response model, so as to obtain an open-loop model; making decisions on control quantities for fast power control resources within the power distribution system based on the open-loop model, and establishing an emergency frequency control optimization model of the power distribution system; and solving the emergency frequency control optimization model of the power distribution system, to obtain a decision-making emergency control scheme with a minimum cost of emergency control measures.

Said establishing an average system frequency response model of the power distribution system includes: obtaining frequency regulation parameters of a wind power generator and a conventional power generator and the magnitude of the load disturbance; based on the frequency regulation parameter of the wind power generator, deriving, using a small-signal analysis method, a wind power-frequency transfer function considering working point shifting; obtaining a frequency response transfer function of the conventional power generator based on the frequency regulation parameter of the conventional power generator; and based on the load disturbance, constructing the average system frequency response model of the power distribution system with reference to the wind power-frequency transfer function and the frequency response transfer function of the conventional power generator.

Said approximating a frequency deviation as a quadratic function based on the average system frequency response model of the power distribution system and under a reasonable assumption that an increase in active power generation of the system increases approximately linearly with time, to perform open-loop processing on the frequency response model, so as to obtain an open-loop model includes: simulating the increase in active power generation of the system using a linear function since the increase in active power generation of the system increases approximately linearly with time after a disturbance occurs in the power system, where the increase in active power generation of the system is equal to a power deficit when frequency reaches a lowest point; after the disturbance occurs, describing a frequency response process of the power system using a rotor motion equation; and integrating the rotor motion equation to obtain a time-domain expression of the frequency.

A Laplace transform is performed on the obtained time-domain expression of the system frequency, to determine the increase in active power generation of the system after the disturbance occurs; an inverse Laplace transform is performed on the increase in active power generation of the system after the disturbance occurs, to obtain a time-domain expression of the increase in active power generation of the system after the disturbance occurs; and when t=t_{nadir}, imbalance power of the system is 0, and the emergency frequency control optimization model of the power distribution system is established.

### Embodiment 2

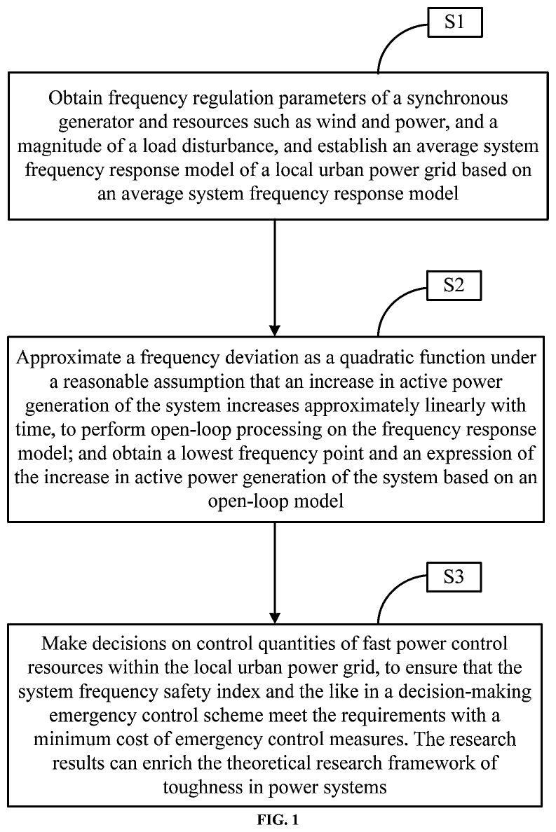

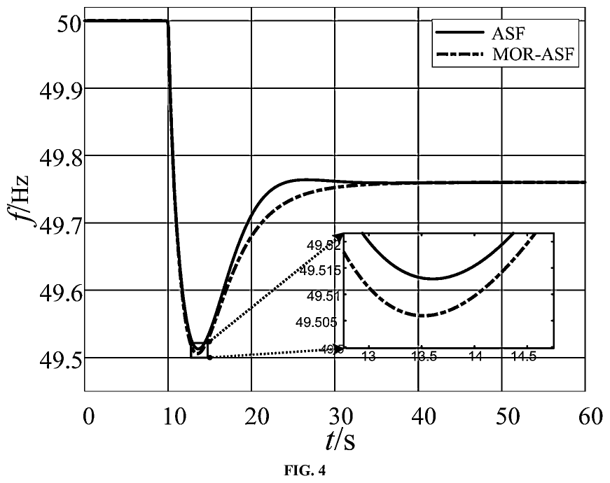

As shown in FIG. 1 to FIG. 4, Embodiment 2 provides a decision-making method for emergency frequency control optimization in an off-grid process of a power distribution system, to improve the toughness of the power distribution system, and the following technical solutions are adopted:

S1: Obtain frequency regulation parameters of power generators and a magnitude of a load disturbance, and establish an average system frequency response model of the power distribution system based on an average system frequency response model. This step may include the following steps:

Frequency regulation parameters of a wind power generator and a conventional power generator and the magnitude of the load disturbance are obtained; and a wind power-frequency transfer function considering working point shifting is derived using a small-signal analysis method:

$$Δ {P}_{w e 1} ( s ) = - \frac{{k}_{P}}{1 + {T}_{W} s} Δ f . \qquad ( 1 )$$

ΔP_{we1} is incremental output power of the wind power generator participating in frequency regulation; s is a Laplace operator; k_{P} is a droop coefficient; Δf is a frequency deviation; and T_{W} is a wind turbine control response time constant.

The frequency regulation parameter of the conventional power generator is obtained; and an expression of a frequency response transfer function of the conventional power generator is as follows:

$$Δ {P}_{S G} ( s ) = - \frac{( 1 + {F}_{h} {T}_{R} s )}{R ( 1 + {T}_{g} s ) ( 1 + {T}_{c h} s ) ( 1 + {T}_{R} s )} Δ f ( s ) . \qquad ( 2 )$$

F_{H}, T_{R}, T_{ch}, T_{g}, and R are a high-pressure cylinder work ratio of a steam turbine in a thermoelectric power generator, a reheater time constant, a volume effect constant of the steam turbine, a governor time constant, and a regulation coefficient; ΔP_{SG} is incremental output power of the conventional power generator during frequency regulation; and Δf(s) is a system frequency variation.

The magnitude of the disturbance is obtained, and the average system frequency response model of the power distribution system is constructed.

S2: Approximate a frequency deviation as a quadratic function based on the average system frequency response model of the power distribution system in S1 and under a reasonable assumption that an increase in active power generation of the system increases approximately linearly with time, to perform open-loop processing on the frequency response model; and obtain a lowest frequency point and an expression of the increase in active power generation of the system based on the open-loop model. This step may include the following steps:

The increase in active power generation of the system can be simulated using a linear function since the increase in active power generation of the system increases approximately linearly with time after a disturbance occurs in the power system. The increase in active power generation of the system is equal to a power deficit when frequency reaches the lowest point. To be specific:

$$D {P}_{m} = \frac{D P}{{t}_{n a d i r}} t , t \hat{I} [ 0 , {t}_{n a d i r} ] . \qquad ( 3 )$$

After the disturbance occurs, a frequency response process of the power system can be described using a rotor motion equation:

$$2 {H}_{s y s} \frac{d D f ( t )}{d t} = D {P}_{m} ( t ) - D {P}_{e} ( t ) + {{å}_{i = 1}}^{n} {x}_{i} u ( t - {t}_{d i} ) . \qquad ( 4 )$$

ΔP is a value of the increase in active power generation of the system when the frequency reaches the lowest point; H is an equivalent inertia time constant of the system; ΔPₘ(t) is a variation of the active power of the power generators within the system over time; ΔPₑ(t) is a variation of electromagnetic power of the system over time; t_{d1},t_{d2}, . . . ,t_{dn} each represent a time delay corresponding to each fast power control resource; and t_{nadir} represents time when the frequency reaches the lowest point;
u(t−t_{di}) is a unit step delay function, as shown in the following formula:

$$u ( t - {t}_{d} ) = \text{?} \begin{matrix}0 & 0 £t < {t}_{d} \\ 1 & {t}^{3} {t}_{d}\end{matrix} . \qquad ( 5 )$$

$$\text{?} \text{indicates text missing or illegible when filed}$$

By integrating the formula (4) in a range t∈[0, t_{nadir}], a time-domain expression of the frequency can be obtained as follows:

$$Δ f ( t ) = \frac{Δ {P}_{d} - {x}_{1} - {x}_{2} - … - {x}_{n}}{2 {H}_{s y s}} ( \frac{1}{2 {t}_{n a d i r}} {t}^{2} - t ) - \frac{{\sum }_{i = 1}^{n} {x}_{i} {t}_{d 1} + {\sum }_{i = 2}^{n} {x}_{i} ( {t}_{d 2} - {t}_{d 1} ) + … + {x}_{n} ( {t}_{d n} - {t}_{dn - 1} )}{2 {H}_{sys}} =. \qquad ( 6 )$$

$${at}^{2} + b t + c$$

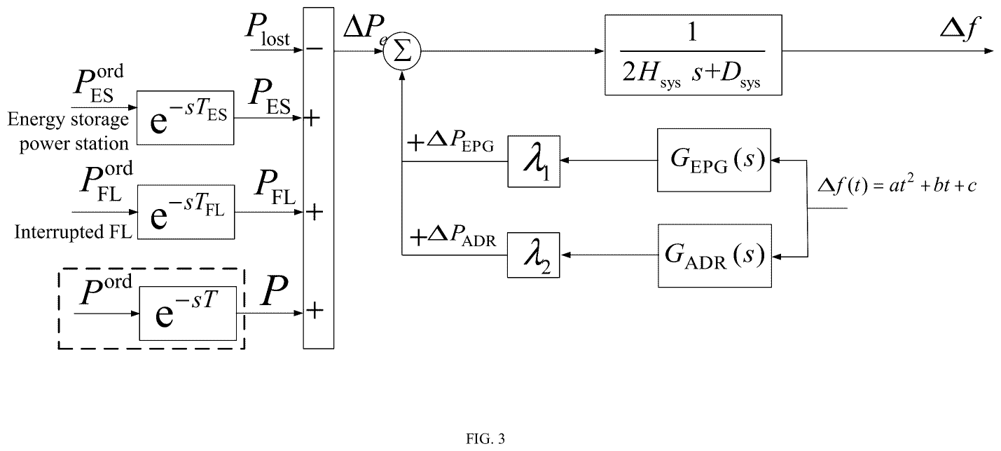

Thus, the frequency response model of the open-loop power distribution system is shown in FIG. 3.

S3: Make decisions on the control quantities of the fast power control resources within the power distribution system based on the open-loop model in S2, to ensure that the system frequency safety index and the like in the decision-making emergency control scheme meet the requirements with the minimum cost of emergency control measures. This step may specifically include the following steps:

A Laplace transform is performed on the time-domain expression of the frequency obtained in the formula (6):

$$Δ f ( s ) = \frac{Δ {P}_{d} - {x}_{1} - {x}_{2} - … - {x}_{n}}{2 {H}_{s y s}} [ \frac{1}{{t}_{n a d i r}} \frac{1}{{s}^{3}} - \frac{1}{{s}^{2}} ] - \frac{{\sum }_{i = 1}^{n} {x}_{i} {t}_{d 1} + {\sum }_{i = 2}^{n} {x}_{i} ( {t}_{d 2} - {t}_{d 1} ) + … + {x}_{n} ( {t}_{d n} - {t}_{dn - 1} )}{2 {H}_{s y s} s} . \qquad ( 7 )$$

In this case, the increase ΔPₘ(s) in active power generation of the system after the disturbance occurs is:

$$Δ {P}_{m} ( s ) = - {G}_{s y s} ( s ) Δ f ( s ) = - \frac{Δ {P}_{d} - {x}_{1} - {x}_{2} - … - {x}_{n}}{2 {H}_{s y s}} [ \frac{1}{{t}_{n a d i r}} \frac{{G}_{s y s} ( s )}{{s}^{3}} - \frac{{G}_{s y s} ( s )}{{s}^{2}} ] + \frac{{\sum }_{i = 1}^{n} {x}_{i} {t}_{d 1} + {\sum }_{i = 2}^{n} {x}_{i} ( {t}_{d 2} - {t}_{d 1} ) + … + {x}_{n} ( {t}_{d n} - {t}_{dn - 1} )}{2 {H}_{s y s} s} {G}_{s y s} ( s ) . \qquad ( 8 )$$

G_{sys} is the transfer function of the system.

An inverse Laplace transform is performed on ΔPₘ(s) to obtain a time-domain expression ΔPₘ(t) of the increase in active power generation of the system after the disturbance occurs. When nadir, unbalanced power of the system is 0, and therefore,

$$D {P}_{m} ( {t}_{n a d i r} ) = D {P}_{d} - {{å}_{i = 1}}^{n} {x}_{i} . \qquad ( 10 )$$

In this way, the emergency frequency control optimization model of the power distribution system can be established:

$$min {c}_{1} {x}_{1} + {c}_{2} {x}_{2} + … + {c}_{n} {x}_{n}$$

$$s . t . \vert Df ( {t}_{n a d i r} ) \vert £ \vert {Df}_{m} \vert$$

$${DP}_{m} ( {t}_{n a d i r} ) = D {P}_{d} - {{å}_{i = 1}}^{n} {x}_{i}$$

$$\begin{matrix}{\underline{x}}_{1} £ {x}_{1} £ {\overline{x}}_{1} \\ {\underline{x}}_{2} £ {x}_{2} £ {\overline{x}}_{2} \\ ⋮ \\ {\underline{x}}_{n} £ {x}_{n} £ {\overline{x}}_{n}\end{matrix} . \qquad ( 11 )$$

Dfₘ is a maximum allowable frequency deviation of the system, the first constraint indicates that the maximum frequency variation of the system is less than the maximum allowable frequency deviation of the system; the second constraint indicates that when t=t_{nadir}, the unbalanced power of the system is 0; and x₁, x₂, . . . , xₙ and x̅₁, x̅₂, . . . , xₙ are upper and lower limits of the adjustable amount for each fast power control resource. c₁, c₂, . . . , cₙ each are a cost corresponding to each fast power control resource.

By solving the above optimization model, the control quantity of each fast power control resource can be obtained, such that the maximum frequency deviation after emergency control action is within a reasonable range at the lowest cost.

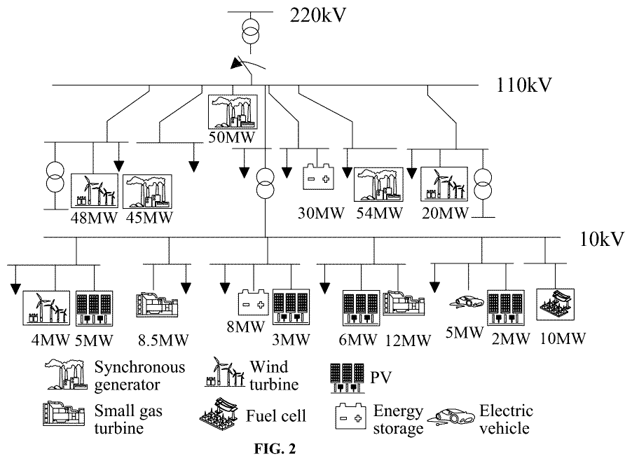

The above-mentioned power distribution system includes the power generators and the fast power control resources. Specifically, as shown in FIG. 2, the power generators in the power distribution system may include one or more types of synchronous generators, wind turbines, photovoltaic systems, or small gas turbines. The fast power control resources may include one or more types of fuel cells, energy storages, and loads (such as electric vehicles in FIG. 2, interrupted flexible loads (FL) in FIG. 3, and other loads represented by arrows in FIG. 2). Therefore, after the power distribution system is disconnected from the grid, the decision-making emergency control scheme with a minimum cost of emergency control measures can be obtained according to the aforementioned steps. Then, the active powers generated by the fast power control resources is increased according to the control quantities for the fast power control resources in the decision-making emergency control scheme, which may include increasing the active power output from at least one of the fuel cells and energy storages, and/or reducing the loads (such as disconnecting certain loads, like electric vehicles).

In this embodiment, according to the decision-making method for emergency frequency control optimization in an off-grid process of a power distribution system, the frequency deviation is approximated as the quadratic function under a reasonable assumption that the increase in active power generation of the system increases approximately linearly with time, and open-loop processing is performed on the frequency response model; the lowest frequency point and the expression of the increase in active power generation of the system are obtained based on the open-loop model; decisions are made on the control quantities of the fast power control resources within the power distribution system, to ensure that the system frequency safety index and the like in the decision-making emergency control scheme meet the requirements with the minimum cost of emergency control measures.

### Embodiment 3

Embodiment 3 provides a non-transitory computer-readable storage medium. The non-transitory computer-readable storage medium stores a computer instruction, and the computer instruction is executed by a processor to achieve the above decision-making method for emergency frequency control optimization in an off-grid process of a power distribution system. The method includes:
obtaining frequency regulation parameters of power generators and a magnitude of a load disturbance, and establishing an average system frequency response model of the power distribution system based on an average system frequency response model;
approximating a frequency deviation as a quadratic function based on the average system frequency response model of the power distribution system and under a reasonable assumption that an increase in active power generation of the system increases approximately linearly with time, to perform open-loop processing on the frequency response model, so as to obtain an open-loop model;
making decisions on control quantities for fast power control resources within the power distribution system based on the open-loop model, and establishing an emergency frequency control optimization model of the power distribution system; and
solving the emergency frequency control optimization model of the power distribution system, to obtain a decision-making emergency control scheme with a minimum cost of emergency control measures.

### Embodiment 4

Embodiment 4 provides a computer device, including a memory and a processor. The processor communicates with the memory, the memory stores a program instruction executable by the processor, and the processor calls the program instruction to perform the decision-making method for emergency frequency control optimization in an off-grid process of a power distribution system. The method includes:
obtaining frequency regulation parameters of power generators and a magnitude of a load disturbance, and establishing an average system frequency response model of the power distribution system based on an average system frequency response model;
approximating a frequency deviation as a quadratic function based on the average system frequency response model of the power distribution system and under a reasonable assumption that an increase in active power generation of the system increases approximately linearly with time, to perform open-loop processing on the frequency response model, so as to obtain an open-loop model;
making decisions on control quantities for fast power control resources within the power distribution system based on the open-loop model, and establishing an emergency frequency control optimization model of the power distribution system; and
solving the emergency frequency control optimization model of the power distribution system, to obtain a decision-making emergency control scheme with a minimum cost of emergency control measures.

### Embodiment 5

Embodiment 5 provides an electronic device, including: a processor, a memory, and a computer program. The processor is connected with the memory, the computer program is stored in the memory, and when the electronic device runs, the processor executes the computer program stored in the memory, to enable the electronic device to execute instructions for achieving the above decision-making method for emergency frequency control optimization in an off-grid process of a power distribution system. The method includes:
obtaining frequency regulation parameters of power generators and a magnitude of a load disturbance, and establishing an average system frequency response model of the power distribution system based on an average system frequency response model;
approximating a frequency deviation as a quadratic function based on the average system frequency response model of the power distribution system and under a reasonable assumption that an increase in active power generation of the system increases approximately linearly with time, to perform open-loop processing on the frequency response model, so as to obtain an open-loop model;
making decisions on control quantities for fast power control resources within the power distribution system based on the open-loop model, and establishing an emergency frequency control optimization model of the power distribution system; and
solving the emergency frequency control optimization model of the power distribution system, to obtain a decision-making emergency control scheme with a minimum cost of emergency control measures.

A person skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may adopt a form of a computer program product that is implemented on one or more computer-usable storage media (including but not limited to a disk memory, a compact disc read-only memory (CD-ROM), and an optical memory) that include computer program codes.

The present disclosure is described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, such that the instructions executed by a computer or a processor of another programmable data processing device generate an apparatus for implementing a specific function in one or more processes in the flowcharts and/or in one or more blocks in the block diagrams.

These computer program instructions may be stored in a computer-readable memory that can instruct a computer or another programmable data processing device to work in a specific manner, such that the instructions stored in the computer-readable memory generate an artifact that includes an instruction apparatus. The instruction apparatus implements a specific function in one or more processes in the flowcharts and/or in one or more blocks in the block diagrams.

These computer program instructions may be loaded onto a computer or other programmable data processing devices such that a series of operations are performed on the computer or other programmable devices, to generate computer-implemented processing. Therefore, the instructions executed on the computer or other programmable devices provide operations for implementing a specific function in one or more processes in the flowcharts and/or in one or more blocks in the block diagrams.

The above describes the specific implementations of the present disclosure with reference to the accompanying drawings, but is not intended to limit the protection scope of the present disclosure. Those skilled in the art should understand that any modifications or variations made by those skilled in the art based on the technical solutions of the present disclosure without creative efforts still fall within the protection scope of the present disclosure.

What is claimed is:

1. A decision-making method for emergency frequency control optimization in an off-grid process of a power distribution system, comprising:
obtaining frequency regulation parameters of power generators and a magnitude of a load disturbance, and establishing an average system frequency response model of the power distribution system based on an average system frequency response model;
approximating a frequency deviation as a quadratic function based on the average system frequency response model of the power distribution system and under a reasonable assumption that an increase in active power generation of the system increases approximately linearly with time, to perform open-loop processing on the frequency response model, so as to obtain an open-loop model;
making decisions on control quantities for fast power control resources within the power distribution system based on the open-loop model, and establishing an emergency frequency control optimization model of the power distribution system; and
solving the emergency frequency control optimization model of the power distribution system, to obtain a decision-making emergency control scheme with a minimum cost of emergency control measures;
controlling the fast power control resources within the power distribution system to generate additional active powers according to the control quantities for the fast power control resources in the decision-making emergency control scheme; wherein the power distribution system comprises the power generators and the fast power control resources.

2. The decision-making method for emergency frequency control optimization in the off-grid process of the power distribution system according to claim 1, wherein said establishing an average system frequency response model of the power distribution system comprises: obtaining frequency regulation parameters of a wind power generator and a conventional power generator and the magnitude of the load disturbance; based on the frequency regulation parameter of the wind power generator, deriving, using a small-signal analysis method, a wind power-frequency transfer function considering working point shifting; obtaining a frequency response transfer function of the conventional power generator based on the frequency regulation parameter of the conventional power generator; and based on the load disturbance, constructing the average system frequency response model of the power distribution system with reference to the wind power-frequency transfer function and the frequency response transfer function of the conventional power generator.

3. The decision-making method for emergency frequency control optimization in the off-grid process of the power distribution system according to claim 2, wherein said approximating a frequency deviation as a quadratic function based on the average system frequency response model of the power distribution system and under a reasonable assumption that an increase in active power generation of the system increases approximately linearly with time, to perform open-loop processing on the frequency response model, so as to obtain an open-loop model comprises: simulating the increase in active power generation of the system using a linear function since the increase in active power generation of the system increases approximately linearly with time after a disturbance occurs in the power system, wherein the increase in active power generation of the system is equal to a power deficit when frequency reaches a lowest point; after the disturbance occurs, describing a frequency response process of the power system using a rotor motion equation; and integrating the rotor motion equation to obtain a time-domain expression of the frequency.

4. The decision-making method for emergency frequency control optimization in the off-grid process of the power distribution system according to claim 3, wherein a Laplace transform is performed on the obtained time-domain expression of the system frequency, to determine the increase in active power generation of the system after the disturbance occurs; an inverse Laplace transform is performed on the increase in active power generation of the system after the disturbance occurs, to obtain a time-domain expression of the increase in active power generation of the system after the disturbance occurs; and when t=t_{nadir}, imbalance power of the system is 0, and the emergency frequency control optimization model of the power distribution system is established.

5. The decision-making method for emergency frequency control optimization in the off-grid process of the power distribution system according to claim 4, wherein the wind power-frequency transfer function considering working point shifting is derived using the small-signal analysis method as:
$$Δ {P}_{we 1} ( s ) = - \frac{{k}_{P}}{1 + {T}_{W} s} Δ f ,$$
wherein
ΔP_{we1} is incremental output power of the wind power generator participating in frequency regulation; s is a Laplace operator; k_{P} is a droop coefficient; Δf is a frequency variation; and T_{W} is a wind turbine control response time constant; and
an expression of the frequency response transfer function of the conventional power generator is:
$$Δ {P}_{S G} ( s ) = - \frac{( 1 + {F}_{h} {T}_{R} s )}{R ( 1 + {T}_{g} s ) ( 1 + {T}_{c h} s ) ( 1 + {T}_{R} s )} Δ f ( s ) ,$$
wherein
Fₕ, T_{R}, T_{ch}, T_{g}, and R are a high-pressure cylinder work ratio of a steam turbine in a thermoelectric power generator, a reheater time constant, a volume effect constant of the steam turbine, a governor time constant, and a regulation coefficient; ΔP_{SG} is incremental output power of the conventional power generator during frequency regulation; and Δf(s) is a system frequency variation.

6. The decision-making method for emergency frequency control optimization in the off-grid process of the power distribution system according to claim 5, wherein
the increase in active power generation of the system is equal to the power deficit when the frequency reaches the lowest point, specifically:
$$D {P}_{m} = \frac{D P}{{t}_{n a d i r}} t , t \hat{I} [ 0 , {t}_{n a d i r} ] ;$$
after the disturbance occurs, the frequency response process of the power system is described using the rotor motion equation as:
$$2 {H}_{s y s} \frac{d D f ( t )}{d t} = D {P}_{m} ( t ) - D {P}_{e} ( t ) + {{å}_{i = 1}}^{n} {x}_{i} u ( t - {t}_{d i} ) ,$$
wherein
ΔP is a value of the increase in active power generation of the system when the frequency reaches the lowest point; H is an equivalent inertia time constant of the system; ΔPₘ(t) is a variation of the active power of the system over time; ΔPₑ(t) is a variation of electromagnetic power of the system over time; t_{d1},t_{d2},t_{dn} each represent a time delay corresponding to each fast power control resource; and t_{nadir} represents time when the frequency reaches the lowest point; and
u (t−t_{di}) is a unit step delay function:
$$u ( t - {t}_{d} ) = \text{?} \begin{matrix}0 & 0 £ t < {t}_{d} \\ 1 & {t}^{3} {t}_{d}\end{matrix} .$$
$$\text{?} \text{indicates text missing or illegible when filed}$$

7. The decision-making method for emergency frequency control optimization in the off-grid process of the power distribution system according to claim 6, wherein the rotor motion equation of the frequency response process of the power system after the disturbance occurs is integrated over a range tÎ[0,t_{nadir}], to obtain the time-domain expression of the frequency:
$$Δ f ( t ) = \frac{Δ {P}_{d} - {x}_{1} - {x}_{2} - … - {x}_{n}}{2 {H}_{s y s}} ( \frac{1}{2 {t}_{n a d i r}} {t}^{2} - t ) - \frac{{\sum }_{i = 1}^{n} {x}_{i} {t}_{d 1} + {\sum }_{i = 2}^{n} {x}_{i} ( {t}_{d 2} - {t}_{d 1} ) + … + {x}_{n} ( {t}_{d n} - {t}_{dn - 1} )}{2 {H}_{s y s}} = ,$$
$${at}^{2} + b t + c$$
wherein a, b, and c are constants.

8. The decision-making method for emergency frequency control optimization in the off-grid process of the power distribution system according to claim 1, wherein the fast power control resources comprise an energy storage, a fuel cell and a load;
the controlling the fast power control resources within the power distribution system to generate additional active powers according to the control quantities for the fast power control resources in the decision-making emergency control scheme comprises:
according to the control quantities for the fast power control resources, controlling at least one of the energy storage and fuel cell to generate additional active powers and controlling the load in the power distribution system to disconnect from the power distribution system.

9. A decision-making system for emergency frequency control optimization in an off-grid process of a power distribution system, comprising:
a first establishing module configured to obtain frequency regulation parameters of power generators and a magnitude of a load disturbance, and establish an average system frequency response model of the power distribution system based on an average system frequency response model;
an open-loop module configured to approximate a frequency deviation as a quadratic function based on the average system frequency response model of the power distribution system and under a reasonable assumption that an increase in active power generation of the system increases approximately linearly with time, to perform open-loop processing on the frequency response model, so as to obtain an open-loop model;
a second establishing module configured to make decisions on control quantities for fast power control resources within the power distribution system based on the open-loop model, and establish an emergency frequency control optimization model of the power distribution system; and
a solving module configured to solve the emergency frequency control optimization model of the power distribution system, to obtain a decision-making emergency control scheme with a minimum cost of emergency control measures;
a controlling module configured to control the fast power control resources within the power distribution system to generate additional active powers according to the control quantities for the fast power control resources in the decision-making emergency control scheme; wherein the power distribution system comprises the power generators and the fast power control resources.

10. The decision-making system for emergency frequency control optimization in the off-grid process of the power distribution system according to claim 9, wherein the fast power control resources comprise an energy storage, a fuel cell and a load;
the controlling module is further configured to, according to the control quantities for the fast power control resources, control at least one of the energy storage and fuel cell to generate additional active powers and control the load in the power distribution system to disconnect from the power distribution system.

11. A computer device, comprising a memory and a processor, wherein the processor communicates with the memory, the memory stores a program instruction executable by the processor, and the processor calls the program instruction to perform the decision-making method for emergency frequency control optimization in the off-grid process of the power distribution system according to claim 1.

12. An electronic device, comprising: a processor, a memory, and a computer program, wherein the processor is connected with the memory, the computer program is stored in the memory, and when the electronic device runs, the processor executes the computer program stored in the memory, to enable the electronic device to execute instructions for achieving the decision-making method for emergency frequency control optimization in the off-grid process of the power distribution system according to claim 1.

13. The computer device according to claim 11, wherein said establishing an average system frequency response model of the power distribution system comprises: obtaining frequency regulation parameters of a wind power generator and a conventional power generator and the magnitude of the load disturbance; based on the frequency regulation parameter of the wind power generator, deriving, using a small-signal analysis method, a wind power-frequency transfer function considering working point shifting; obtaining a frequency response transfer function of the conventional power generator based on the frequency regulation parameter of the conventional power generator; and based on the load disturbance, constructing the average system frequency response model of the power distribution system with reference to the wind power-frequency transfer function and the frequency response transfer function of the conventional power generator.

14. The computer device according to claim 13, wherein said approximating a frequency deviation as a quadratic function based on the average system frequency response model of the power distribution system and under a reasonable assumption that an increase in active power generation of the system increases approximately linearly with time, to perform open-loop processing on the frequency response model, so as to obtain an open-loop model comprises: simulating the increase in active power generation of the system using a linear function since the increase in active power generation of the system increases approximately linearly with time after a disturbance occurs in the power system, wherein the increase in active power generation of the system is equal to a power deficit when frequency reaches a lowest point; after the disturbance occurs, describing a frequency response process of the power system using a rotor motion equation; and integrating the rotor motion equation to obtain a time-domain expression of the frequency.

15. The computer device according to claim 14, wherein a Laplace transform is performed on the obtained time-domain expression of the system frequency, to determine the increase in active power generation of the system after the disturbance occurs; an inverse Laplace transform is performed on the increase in active power generation of the system after the disturbance occurs, to obtain a time-domain expression of the increase in active power generation of the system after the disturbance occurs; and when t=t_{nadir}, imbalance power of the system is 0, and the emergency frequency control optimization model of the power distribution system is established.

16. The computer device according to claim 15, wherein the wind power-frequency transfer function considering working point shifting is derived using the small-signal analysis method as:
$$Δ {P}_{w e 1} ( s ) = - \frac{{k}_{P}}{1 + {T}_{W} s} Δ f ,$$
wherein
ΔP_{we1} is incremental output power of the wind power generator participating in frequency regulation; s is a Laplace operator; k_{P} is a droop coefficient; Δf is a frequency variation; and T_{W} is a wind turbine control response time constant; and
an expression of the frequency response transfer function of the conventional power generator is:
$$Δ {P}_{S G} ( s ) = - \frac{( 1 + {F}_{h} {T}_{R} s )}{R ( 1 + {T}_{g} s ) ( 1 + {T}_{c h} s ) ( 1 + {T}_{R} s )} Δ f ( s ) ,$$
wherein
Fₕ, T_{R}, T_{ch}, T_{g}, and R are a high-pressure cylinder work ratio of a steam turbine in a thermoelectric power generator, a reheater time constant, a volume effect constant of the steam turbine, a governor time constant, and a regulation coefficient; ΔP_{SG} is incremental output power of the conventional power generator during frequency regulation; and Δf(s) is a system frequency variation.

17. The computer device according to claim 16, wherein
the increase in active power generation of the system is equal to the power deficit when the frequency reaches the lowest point, specifically:
$$D {P}_{m} = \frac{D P}{{t}_{n a d i r}} t , t \hat{I} [ 0 , {t}_{n a d i r} ] ;$$
after the disturbance occurs, the frequency response process of the power system is described using the rotor motion equation as:
$$2 {H}_{s y s} \frac{d D f ( t )}{d t} = D {P}_{m} ( t ) - D {P}_{e} ( t ) + {{å}_{i = 1}}^{n} {x}_{i} u ( t - {t}_{d i} ) ,$$
wherein
ΔP is a value of the increase in active power generation of the system when the frequency reaches the lowest point; H is an equivalent inertia time constant of the system; ΔPₘ(t) is a variation of the active power of the system over time; ΔPₑ(t) is a variation of electromagnetic power of the system over time; t_{d1},t_{d2}, . . . ,t_{dn} an each represent a time delay corresponding to each fast power control resource; and t_{nadir} represents time when the frequency reaches the lowest point; and
u(t−t_{di}) is a unit step delay function:
$$u ( t - {t}_{d} ) = \text{?} \begin{matrix}0 & 0 £ t < {t}_{d} \\ 1 & {t}^{3} {t}_{d}\end{matrix} .$$
$$\text{?} \text{indicates text missing or illegible when filed}$$

18. The computer device according to claim 17, wherein the rotor motion equation of the frequency response process of the power system after the disturbance occurs is integrated over a range tÎ[0,t_{nadir}], to obtain the time-domain expression of the frequency:
$$Δ f ( t ) = \frac{Δ {P}_{d} - {x}_{1} - {x}_{2} - … - {x}_{n}}{2 {H}_{s y s}} ( \frac{1}{2 {t}_{n a d i r}} {t}^{2} - t ) - \frac{{\sum }_{i = 1}^{n} {x}_{i} {t}_{d 1} + {\sum }_{i = 2}^{n} {x}_{i} ( {t}_{d 2} - {t}_{d 1} ) + … + {x}_{n} ( {t}_{d n} - {t}_{dn - 1} )}{2 {H}_{s y s}} = ,$$
$${at}^{2} + b t + c$$
wherein a, b, and c are constants.

19. The computer device according to claim 11, wherein the fast power control resources comprise an energy storage, a fuel cell and a load;
the controlling the fast power control resources within the power distribution system to generate additional active powers according to the control quantities for the fast power control resources in the decision-making emergency control scheme comprises:
according to the control quantities for the fast power control resources, controlling at least one of the energy storage and fuel cell to generate additional active powers, and controlling the load in the power distribution system to disconnect from the power distribution system.

20. The electronic device according to claim 12, wherein said establishing an average system frequency response model of the power distribution system comprises: obtaining frequency regulation parameters of a wind power generator and a conventional power generator and the magnitude of the load disturbance; based on the frequency regulation parameter of the wind power generator, deriving, using a small-signal analysis method, a wind power-frequency transfer function considering working point shifting; obtaining a frequency response transfer function of the conventional power generator based on the frequency regulation parameter of the conventional power generator; and based on the load disturbance, constructing the average system frequency response model of the power distribution system with reference to the wind power-frequency transfer function and the frequency response transfer function of the conventional power generator.
